(19) United States
(12) Patent Application Publication
(10) Pub. No.: US 2013/0061876 A1
(43) Pub. Date: Mar. 14, 2013

(54) Semiconductor Device Surface Clean

(71) Applicants: Shich-Chang Suen, Hsin-Chu City (TW); He Hui Peng, Changhua City (TW); Liang-Guang Chen, Hsin-Chu (TW)

(72) Inventors: Shich-Chang Suen, Hsin-Chu City (TW); He Hui Peng, Changhua City (TW); Liang-Guang Chen, Hsin-Chu (TW)

(73) Assignee: Taiwan Semiconductor Manufacturing Company, Ltd., Hsin-Chu (TW)

(21) Appl. No.: 13/232,508

(22) Filed: Sep. 14, 2011

(51) Int. Cl. B08B 1/00

(52) U.S. Cl. 134/6

(57) ABSTRACT

A system and method for cleaning a surface of a semiconductor device is disclosed. An embodiment comprises buffing the first surface with a cleaning solution comprising a reactant that will remove a portion of the first surface and also change the first surface from hydrophobic to hydrophilic. The first surface may further be cleaned using a brushing process that also utilizes the cleaning solution.

### BACKGROUND

Generally, contacts down to a semiconductor substrate may be made by first forming a dielectric layer and then forming openings within the dielectric layer to expose the underlying substrate where contact is desired to be made. Once the openings have been formed, a barrier layer may be formed within the openings and conductive material may be used to fill the remainder of the openings using, e.g., a plating process. This plating process usually fills and overfills the openings, causing a layer of the conductive material to extend up beyond the dielectric layer.

A chemical mechanical polish (CMP) may be performed to remove the excess conductive material and the barrier layer from outside of the openings and to isolate the conductive material and the barrier layer within the openings. For example, the excess conductive material may be contacted to a polishing pad, and the two may be rotated in order to grind excess conductive material away. This grinding process may be assisted by the use of a CMP slurry, which may contain chemicals and abrasives that can assist in the grinding process and help remove the conductive material.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 illustrates a substrate with overlying dielectric layers and contact openings overfilled with a conductive material in accordance with an embodiment;

FIG. 2 illustrates a chemical mechanical polishing (CMP) system in accordance with an embodiment;

FIG. 3A-3B illustrate a bulk CMP process and result in accordance with an embodiment;

FIGS. 4A-4B illustrate a buffing CMP process and result in accordance with an embodiment;

FIGS. 5A-5B illustrate a cleaning buff process and result in accordance with an embodiment;

FIG. 6 illustrates a brush cleaning process in accordance with an embodiment;

FIG. 7 illustrates a pencil cleaning process in accordance with an embodiment;

FIG. 8 illustrates a result of the brush cleaning process and the pencil cleaning process in accordance with an embodiment; and

FIGS. 9A-9B illustrate test results comparing the embodiments to deionized water cleaning process in accordance with an embodiment.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments are discussed in detail below. It should be appreciated, however, that the embodiments provide many applicable concepts that can be embodied in a wide variety of specific contexts. The embodiments discussed are merely illustrative of specific ways to make and use the embodiments, and do not limit the scope of the embodiments.

The embodiments will be described with respect to embodiments in a specific context, namely a surface clean of a polishing stop layer for a tungsten plug in a metal zero layer. The embodiments may also be applied, however, to other surface cleaning processes.

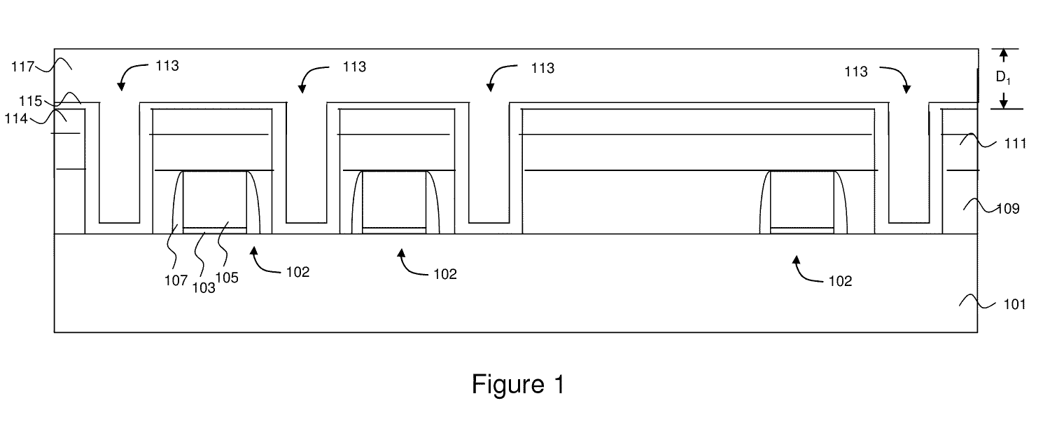

With reference now to FIG. 1, there is shown a substrate 101 with a plurality of gate stacks 102 on the substrate 101, a first inter-layer dielectric (ILD) layer 109, a first polishing stop layer 111, a sacrificial layer 114, openings 113 through the sacrificial layer 114, the first ILD layer 109, and the first polishing stop layer 111, a barrier layer 115, and a conductive fill material 117. The substrate 101 may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

The gate stacks 102 on the substrate 101 may comprise gate dielectrics 103, gate electrodes 105, and spacers 107. The gate dielectrics 103 may be a dielectric material, such as silicon oxide, silicon oxynitride, silicon nitride, an oxide, a nitrogen-containing oxide, a combination thereof, or the like. The gate dielectrics 103 may have a relative permittivity value greater than about 4. Other examples of such materials include aluminum oxide, lanthanum oxide, hafnium oxide, zirconium oxide, hafnium oxynitride, or combinations thereof.

In an embodiment in which the gate dielectrics 103 comprise an oxide layer, the gate dielectrics 103 may be formed by any oxidation process, such as a wet or dry thermal oxidation in an ambient comprising an oxide, H₂O, NO, or a combination thereof. Alternatively, the gate dielectrics 103 may be formed by chemical vapor deposition (CVD) techniques using tetra-ethyl-ortho-silicate (TEOS) and oxygen as a precursor. In an embodiment, the gate dielectrics 103 may be between about 8 Å to about 200 Å in thickness.

The gate electrodes 105 may comprise a conductive material, such as a metal (e.g., tantalum, titanium, molybdenum, tungsten, platinum, aluminum, hafnium, ruthenium), a metal silicide (e.g., titanium silicide, cobalt silicide, nickel silicide, tantalum silicide), a metal nitride (e.g., titanium nitride, tantalum nitride), doped poly-crystalline silicon, other conductive materials, combinations thereof, or the like. In an embodiment in which the gate electrodes 105 are poly-silicon, the gate electrodes 105 may be formed by depositing doped or undoped poly-silicon by low-pressure chemical vapor deposition (LPCVD) to a thickness in the range of about 400 Å to about 2,400 Å, such as about 1,400 Å.

Once the gate dielectrics 103 and the gate electrodes 105 have been formed, the gate dielectrics 103 and gate electrodes 105 may be patterned. In an embodiment, the gate dielectrics 103 and the gate electrodes 105 may be patterned using, e.g., a photolithographic masking and etching process, whereby a photolithographic mask (not shown in FIG. 1) is formed over the gate electrodes 105 and then exposed to a patterned light. After exposure, desired portions of the photolithographic mask are removed to exposed the underlying gate electrodes 105, which may then be etched to remove the exposed portions, thereby patterning the gate electrodes 105 and the gate dielectrics 103.

The spacers 107 may be formed by blanket depositing one or more spacer layers (not shown) over the gate electrodes 105 and the substrate 101. The spacer layers may comprise SiN, oxynitride, SiC, SiON, oxide, and the like and may be formed by commonly used methods such as chemical vapor deposition (CVD), plasma enhanced CVD, sputter, and other methods known in the art. The spacer layers may be patterned, such as by isotropically or anisotropically etching, thereby removing the spacer layers from the horizontal surfaces of the structure and forming the spacers 107 as illustrated in FIG. 1.

However, as one of ordinary skill in the art will recognize, the process described above and the resulting shape of the spacers 107 as illustrated in FIG. 1 are intended to be merely illustrative and are not intended to limit the embodiments to these descriptions. Rather, any suitable number and combination of spacers layers and shapes may be utilized in order to form spacers for the gate stacks 102, and any suitable combination of spacers may alternatively be utilized.

Additionally, the gate stacks may also be utilized with other elements not shown in FIG. 1 for clarity. For example, source/drain regions may be formed within the substrate adjacent to the gate dielectrics 103. Additionally, silicide regions may be formed on the substrate 101 in order to help lower the resistance between the conductive material 117 and the source/drain regions. These and any other suitable elements that may assist in the functioning of the gate stacks 102 may also be formed along with the gate stacks 102, and are fully intended to be included within the scope of the embodiments.

The first ILD layer 109 may be formed over the gate stacks 102 and the substrate 101 in order to provide electrical isolation between the substrate 101, the gate stacks 102, and overlying metallization layers (not shown in FIG. 1). The first ILD layer 109 may be formed by chemical vapor deposition, sputtering, or any other methods known and used in the art for forming an ILD. The first ILD layer 109 may have a planarized surface and may be comprised of doped or undoped silicon oxide, silicon nitride doped silicate glass, other high-k materials, combinations of these, or the like, could alternatively be utilized. After formation, the first ILD layer 109 may be planarized using, e.g., a chemical mechanical polish (CMP) process in order to planarize the first ILD layer 109 and expose the gate electrodes 105.

The first polishing stop layer 111 may be formed over the first ILD layer 109 and the gate electrodes 105. The first polishing stop layer 111 may be used to protect the gate stacks 102 and other devices from damage caused by further processing such as polishing and to provide for a stopping control point for polishing. In one embodiment, the first polishing stop layer 111 may be formed of silicon nitride using plasma enhanced chemical vapor deposition (PECVD). Other materials such as silicon carbide, silicon oxynitride, combinations thereof, or the like, and alternative techniques of forming the first polishing stop layer 111, such as low pressure CVD (LPCVD) or PVD, could alternatively be used. The first polishing stop layer 111 may have a thickness of between about 50 Å and about 2,000 Å, such as about 700 Å.

The sacrificial layer 114 may be formed over the first polishing stop layer 111 in order to help a subsequent CMP process. In an embodiment the sacrificial layer 114 may be a sacrificial oxide, such as silicon oxide, although any other suitable sacrificial material may be utilized. In an embodiment in which the sacrificial layer 114 is a sacrificial oxide, the sacrificial layer 114 may be formed by chemical vapor deposition (CVD) techniques using tetra-ethyl-ortho-silicate (TEOS) and oxygen as a precursor. The sacrificial layer 114 may be between about 300 Å to about 600 Å in thickness.

Once the sacrificial layer 114 has been formed, contact openings 113 may be formed through the sacrificial layer 114, the first polishing stop layer 111, and the first ILD layer 109. The contact openings 113 may be formed through a series of sequential etchings using a suitable photolithographic process, such as depositing a photoresist material and then exposing and developing the photoresist material to expose portions of the sacrificial layer 114 that are to be removed. The remaining photoresist material protects the underlying material from subsequent processing steps, such as etching. In an embodiment the photoresist material is utilized to create a patterned mask to define the contact openings 113, but additional masks, such as a hardmask, may also be used. The etching process may be an anisotropic or isotropic etch process, such as an anisotropic dry etch process. In an embodiment, multiple etch processes using a suitable etchant or combination of etchants may be sequentially performed through the sacrificial layer 114, the first polishing stop layer 111, and the first ILD layer 109.

After the contact openings 113 have been formed to expose the substrate 101 a barrier layer 115 may be formed to line the contact openings 113. In an embodiment, the barrier layer 115 may be formed of one or more layers of titanium nitride, titanium, tantalum, tantalum nitride, tungsten nitride, ruthenium, rhodium, platinum, other noble metals, other refractory metals, their nitrides, combinations of these, or the like. The barrier layer 115 may be formed through chemical vapor deposition, although other techniques such as PVD or ALD could alternatively be used. The barrier layer 115 may be formed to a thickness of about 5 Å to about 500 Å.

After the barrier layer 115 has been formed, a conductive material 117 may be formed to fill the contact openings 113 and to provide an electrical connection to the substrate 101. The conductive material 117 may be deposited by CVD, ALD or PVD, and may be formed of tungsten, although other suitable materials such as aluminum, copper, tungsten nitride, rhuthenium, silver, gold, rhodium, molybdenum, nickel, cobalt, cadmium, zinc, alloys of these, combinations thereof, and the like, may alternatively be utilized. The conductive material 117 may be deposited into the contact openings 113 and the deposition may be continued until the conductive material 117 fills the contact openings 113 and extends above the sacrificial layer 114 a first distance D₁ of between about 1000 Å and about 5000 Å, such as about 2000 Å.

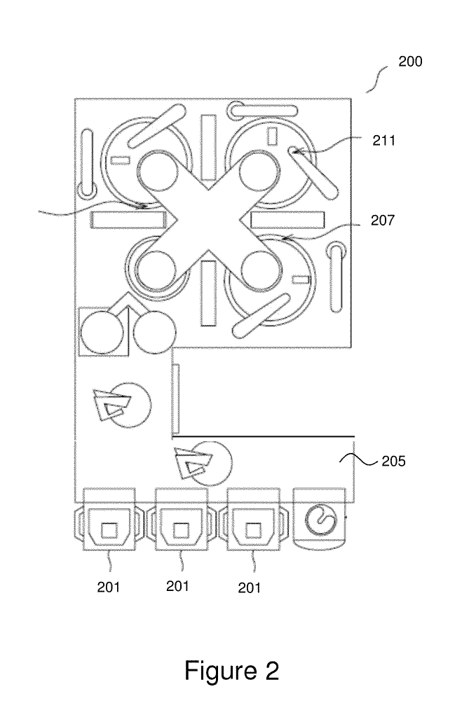

FIG. 2 illustrates a CMP system 200 which may be used to remove the excess conductive material 117, barrier layer 115, and the sacrificial layer 114 from the surface of the first polishing stop layer 111, thereby isolating the conductive material 117 and barrier layer 115 in the contact openings 113. The CMP system 200 may include loadlocks 201, cleaning station 205, a high-rate platen 207, and a buffing platen 211. The loadlocks 201 may be used for loading the substrate 101 into the CMP system 200, and then unloading the substrate 101 once the CMP process has been completed. The high-rate platen 207 may be used for polishing and removing the conductive material 117 with a relatively high polishing rate, such as a bulk polishing rate, while the buffing platen 211 may be used for polishing and removing the sacrificial layer 114 and also to fix defects and scratches that may occur during the removal of the conductive material 117.

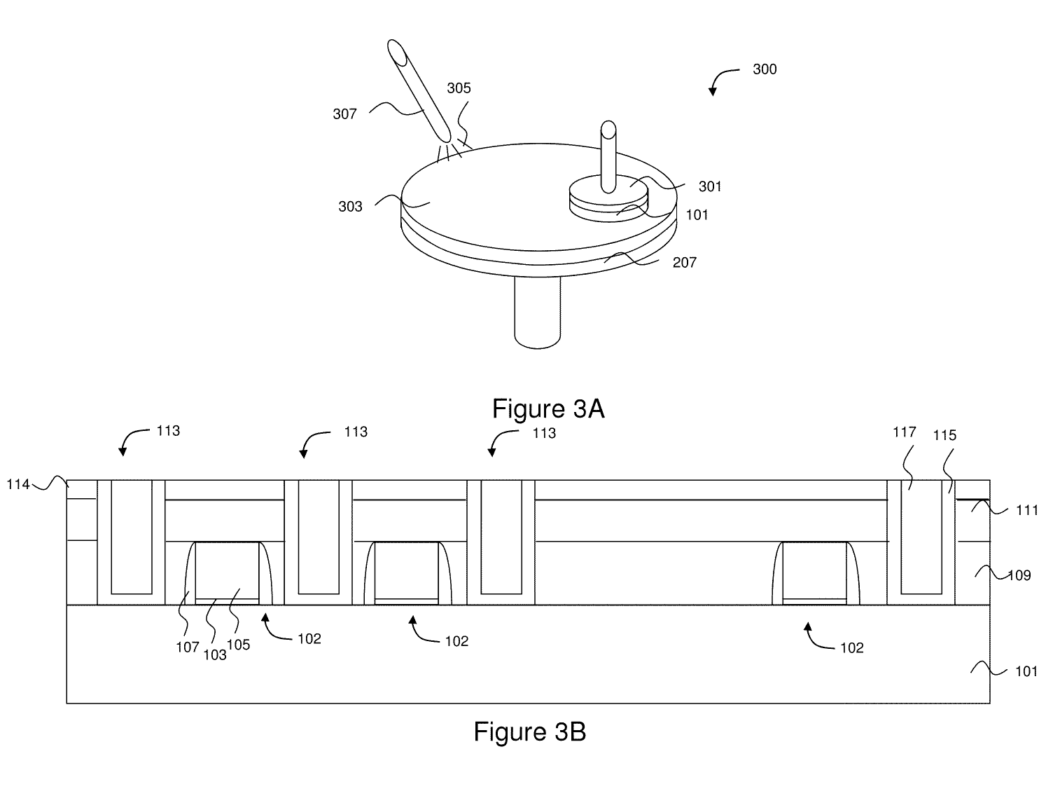

FIGS. 3A-3B illustrate the process and result of a bulk CMP process 300. In an embodiment the substrate 101 (along with the overfilled conductive material 117) may be loaded into the CMP system 200 through the loadlocks 201 and passed to the high-rate platen 207 for a bulk removal of the conductive material 117 (see FIG. 2). Once at the high-rate platen 207 (and as illustrated in FIG. 3A), the substrate 101 may be connected to a first carrier 301, which faces the substrate 101 and the conductive material 117 towards a first polishing pad 303 connected to the high-rate platen 207.

The first polishing pad 303 may be a hard polishing pad that may be utilized for a relatively quick removal of the conductive material 117. In an embodiment the first polishing pad 303 may be a single layer or composite layer of materials such as polyurethane or polyurethane mixed with fillers, and may have a hardness of about 50 or greater on the Shore D Hardness scale. The surface of the first polishing pad 303 may be a roughened surface with micorpores within it. However, any other suitable polishing pad may alternatively be used to remove a bulk of the conductive material 117 from the surface of the sacrificial layer 114 (as illustrated in FIG. 3B).

During the bulk CMP process 300 the first carrier 301 may press the surface of the conductive material 117 against the first polishing pad 303. The substrate 101 and the first polishing pad 303 are each rotated against each other, either in the same direction or else counter-rotated in opposite directions. By rotating the first polishing pad 303 and the substrate 101 against each other, the first polishing pad 303 mechanically grinds away the conductive material 117, thereby effectuating a removal of the conductive material 117. Additionally, in some embodiments the first carrier 301 may move the substrate 101 back and forth along a radius of the first polishing pad 303.

Additionally, the mechanical grinding of the first polishing pad 303 may be assisted through the use of a CMP slurry 305, which may be dispensed onto the first polishing pad 303 through a slurry dispensing system 307. In an embodiment the CMP slurry 305 may comprise a first reactant, an abrasive, a first surfactant, and a solvent. The first reactant may be a chemical that will chemically react with the conductive material 117 in order to assist the first polishing pad 303 in grinding away the conductive material 117, such as an oxidizer. In an embodiment in which the conductive material 117 is tungsten, the first reactant may be hydrogen peroxide, although any other suitable reactant, such as hydroxylamine, periodic acid, ammonium persulfate, other periodates, iodates, peroxomonosulfates, peroxymonosulfuric acid, perborates, malonamide, combinations of these, and the like, that will aid in the removal of the conductive material 117 may alternatively be utilized.

The abrasive may be any suitable particulate that, in conjunction with the first polishing pad 303, aids in the removal of the conductive material 117. In an embodiment the abrasive may be silica (e.g., silicon oxide) with a particle size of between about 0.1 μm and about 150 nm. However, any other suitable abrasive, such as aluminum oxide, cerium oxide, polycrystalline diamond, polymer particles such as polymethacrylate or polymethacryclic, combinations of these, or the like, may alternatively be utilized and are fully intended to be included within the scope of the embodiments.

The first surfactant may be utilized to help disperse the first reactant and abrasive within the CMP slurry 305 and also prevent the abrasive from agglomerating during the CMP process. In an embodiment the first surfactant may include sodium salts of polyacrylic acid, potassium oleate, sulfosuccinates, sulfosuccinate derivatives, sulfonated amines, sulfonated amides, sulfates of alcohols, alkylanyl sulfonates, carboxylated alcohols, alkylamino propionic acids, alkyliminodipropionic acids, potassium oleate, sulfosuccinates, sulfosuccinate derivatives, sulfates of alcohols, alkylanyl sulfonates, carboxylated alcohols, sulfonated amines, sulfonated amides, alkylamino propionic acids, alkyliminodipropionic acids, combinations of these, or the like. However, these embodiments are not intended to be limited to these surfactants, as any suitable surfactant may alternatively be utilized as the first surfactant.

The remainder of the CMP slurry 305 may be a solvent that may be utilized to combine the first reactant, the abrasive, and the first surfactant and allow the mixture to be moved and dispersed onto the first polishing pad 303. In an embodiment the solvent of the CMP slurry 305 may a solvent such as deionized water or an alcohol. However, any other suitable solvent may alternatively be utilized.

Once combined, the CMP slurry 305 may be dispensed onto the first polishing pad 303 by the CMP slurry dispenser 307 in order to assist in the removal of the conductive material 117. In an embodiment in which the conductive material 117 is tungsten, the first reactant may react with the tungsten to form a sacrificial layer of tungsten oxide (not shown) along the exposed surface of the conductive material 117. The tungsten oxide may then be removed by the grinding effect of the first polishing pad 303 along with the assistance of the abrasives within the CMP slurry 305. Using this process, a bulk removal of the conductive material 117 may be performed, and may be continued until the conductive material 117 is removed from the upper surface of the sacrificial layer 114 and the sacrificial layer 114 is exposed.

FIG. 3B illustrates the result of the bulk CMP process 300. As illustrated, the bulk CMP process 300 removes a bulk of the conductive material 117 from the surface of the sacrificial layer 114, and the conductive material 117 is isolated within the contact openings 113 within the sacrificial layer 114, the first polishing stop layer 111, and the first ILD layer 109.

However, as one of ordinary skill in the art will recognize, the above description of a removing the bulk of the excess conductive material 117 outside of the contact openings 113 in a single processing step is merely an illustrative example and is not intended to be limiting upon the embodiments. Any number of removal processes and any number of platens may alternatively be utilized to remove the conductive material 117, and all such combinations are fully intended to be included within the scope of the embodiments.

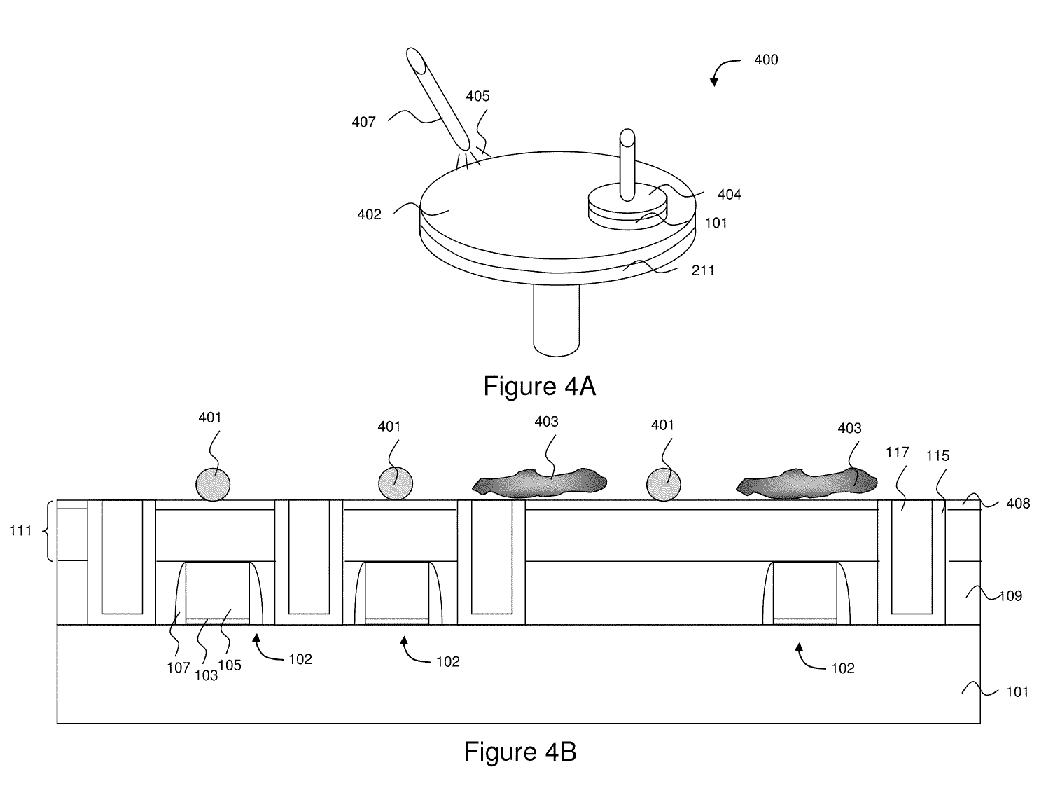

FIGS. 4A-4B illustrate the process and result of a buffing CMP process 400 to remove the sacrificial layer 114. In an embodiment the substrate 101 may be removed from the high-rate platen 207 and may be transferred to the buffing platen 211 (see FIG. 2), where the substrate 101 may be attached to a second carrier 404, which also faces the substrate 101 and the sacrificial layer 114 towards a second polishing pad 402 on the buffing platen 211. The second polishing pad 402 may perform a similar CMP process as the high-rate platen 207, with the second polishing pad 402 grinding away the sacrificial layer 114 and a buffing slurry 405 being dispersed by a buffing slurry dispenser 407 to aid in the grinding process. In an embodiment in which the sacrificial layer 114 is a sacrificial oxide, the buffing slurry 405 may comprise an HNO₃ reactant, a silica abrasive (e.g., SiO₂), a surfactant, and a corrosion inhibitor.

In an embodiment the second polishing pad 402 may be a soft buffing pad which may remove the sacrificial layer 114 at a slower and more controlled rate than the first polishing pad 303 removed the conductive material 117 while also buffing and eliminating defects and scratches that may have been caused by the bulk CMP process 300. In an embodiment the second polishing pad 402 may be rotated relative to the substrate 101 while the buffing slurry 405 is dispensed on the second polishing pad 402. The buffing CMP process 400 may be continued until the sacrificial layer 114 has been removed from the surface of the first polishing stop layer 111, and may use a timed or optical end-point detection to determine when to stop on the first polishing stop layer 109.

FIG. 4B illustrates a result of an embodiment of the buffing CMP process 400, wherein the sacrificial layer 114, the excess conductive material 117, and the barrier layer 115 have been removed from the surface of the first polishing stop layer 111 and have been isolated within the contact openings 113. However, because the CMP slurry 305 with the first reactant and the buffing slurry 405 are usually acids which create a low pH (e.g., a pH of less than about 5), the first polishing stop layer 111 may carry a positive surface charge after the buffing CMP process 400. Additionally, particles 401 such as the abrasive (e.g., SiO₂ with a size of between 30 nm and 50 nm) may have a negative charge during the buffing CMP process 400. This situation of opposite charges can lead to the particles 401 being attracted to the surface of the first polishing stop layer 111, forming a contaminated layer 408 in the upper portion of the first polishing stop layer 111.

Additionally, at this pH level, the surface of the first polishing stop layer 111 will become hydrophobic. As such, any organic material 403 from the process may be attracted to the surface of the first polishing stop layer 111 and also become attached. This organic material 403 and may originate, e.g., as debris from the first polishing pad 404, the first surfactant within the CMP slurry 305, pipeline debris, or other debris from the bulk CMP process 300 and the buffing CMP process 400. The organic material 403, for example, may be between 0.2 μm in size to 1 μm in size.

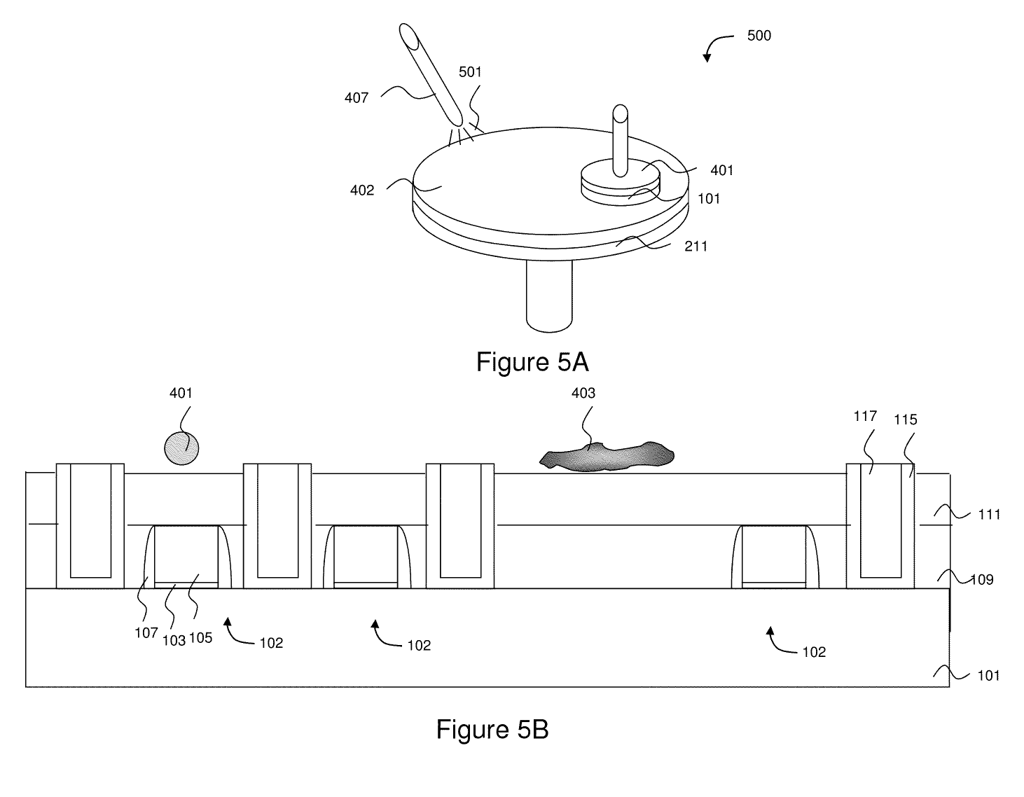

FIGS. 5A-5B illustrate an embodiment to solve this problem of contaminants (e.g., the particles 401 and the organic material 403). To clean the particles 401 and the organic material 403 from the first polishing stop layer 111, a cleaning buffing CMP process 500 may be performed on the first polishing stop layer 111. In an embodiment the cleaning buffing CMP process 500 may be performed utilizing the same buffing platen 211 and the second polishing pad 402 as the buffing CMP process 400 described above with respect to FIG. 4A. In a particular embodiment the cleaning buffing CMP process 500 may be performed at the back end of the buffing CMP process 400 by simply changing the buffing slurry dispenser 407 from dispensing buffing slurry 405 to a cleaning solution 501 (described further below). However, as one of ordinary skill in the art will recognize, the cleaning buffing CMP process 500 may alternatively be performed on a separate platen with a separate polishing pad than the buffing CMP process 400 while still remaining within the scope of the embodiments.

The cleaning buffing CMP process 500 may be performed using a cleaning solution 501 that may comprise a second reactant, an optional second surfactant, and the solvent. In an embodiment the second reactant may be a chemical which can help to remove the contaminated layer 408 and its contaminants (e.g., the particles 401 and the organic material 403) while also reacting with the first polishing stop layer 111 to adjust the hydrophilicity of the first polishing stop layer 111. In an embodiment the second reactant may be phosphoric acid (H₃PO₄), although other suitable chemicals, such as citric acid or oxalic acid, may alternatively be utilized. The second reactant may be between about 0.1% to about 99% of the cleaning solution 501, such as about 5% of the cleaning solution.

Additionally, while the second reactant may be used by itself as the only acid within the cleaning solution 501, additional acids may optionally be added to the cleaning solution 501 along with the second reactant in order to assist the second reactant in its reactions with the first polishing stop layer 111. In an embodiment, acids such as hydrofluoric acid may be added to the cleaning solution 501 along with the second reactant. Such an addition may aid the second reactant in transforming the hydrophilic nature of the first polishing stop layer 111. In other embodiments, a mixture of the acids listed as the second reactant, such as phosphoric acid and citric acid, may also be utilized.

The second surfactant may be a chemical that not only aids in the dispersal of the cleaning solution 501, but may also be used to help the second reactant adjust the hydrophilicity of the first polishing stop layer 111. In an embodiment the second surfactant may be an anionic surfactant such as perfluorooctanoic acid (PFOA), although other anionic surfactants such as perfluorooctanesulfonate (PFOS), and other surfactants such as alkyl aryl ether phosphate and alkyl ether phosphate, may alternatively be utilized. The surfactant may comprise between about 50 ppm and about 2000 ppm, such as about 1000 ppm of the cleaning solution 501, and the remainder of the cleaning solution 501 being made up of the solvent or other materials such as corrosion inhibitors.

Additionally, the cleaning solution 501 may be dispersed onto the second polishing pad 402 at room temperature or ambient temperature while still providing the desired results. By using the cleaning solution 501 at room temperature, there is no requirement that heat be supplied to the cleaning solution 501 in order to initiate or maintain the desired chemical reactions and grinding processes. As such, there are no additional utility costs that must be paid in order to use the cleaning solution 501, leading to a cheaper and more efficient process of manufacturing.

FIG. 5B illustrates a result after an embodiment of the cleaning buffing CMP process 500 in which the first polishing stop layer 111 (and more particularly the contaminated layer 408 of the first polishing stop layer 111) is contacted with the buffing platen 211 and the cleaning solution 501 is applied to the first polishing stop layer 111. As illustrated, the cleaning buffing CMP process 500 utilizing the cleaning solution 501 may be used to remove the contaminated layer 408 along with the particles 401 and the organic material 403. In an embodiment of the cleaning buffing CMP process 500, the second carrier 404 may push the substrate 101 onto the buffing platen 211 with a force of between about 0.5 psi to about 10 psi and a rotation of between about 70 rpm to about 90 rpm. Additionally, the cleaning solution 501 may be dispensed onto the second polishing pad 402 at a rate of between about 300 sccm and about 500 sccm. The cleaning buffing CMP process 500 may remove a portion of the first polishing stop layer 111, such as removing between about 5 Å and about 10 Å of the first polishing stop layer 111, such as about 7 Å, at a rate of about 10 Å per minute.

Additionally, beyond just physically removing a portion of the first polishing stop layer 111 and some of the contaminants (e.g., the particles 401 and organic material 403), the cleaning buffing CMP process 500 with the second reactant and the second surfactant may also affect the hydrophobic nature of the first polishing stop layer 111. In particular, the second reactant and the second surfactant may react with the surface of the first polishing stop layer 111 to change the first polishing stop layer 111 from being hydrophobic into being hydrophilic. This change can aid in the further removal of the particles 401 and organic materials 403 from the surface of the first polishing stop layer 111. In an embodiment in which the first polishing stop layer 111 is silicon nitride and the second reactant is H₃PO₄ the second reactant may react with the silicon nitride as illustrated in Equation 1.

3Si₃N₄+4H₃PO₄+18H₂O→4(NH₄)₃PO₄+9SiO₂ Eq. 1

By forming the products from this reaction, the top surface of the first polishing stop layer 111 may be partially or fully reacted to form a silicon oxide, thereby helping to change the top surface of the first polishing stop layer 111 from being hydrophobic to being hydrophilic.

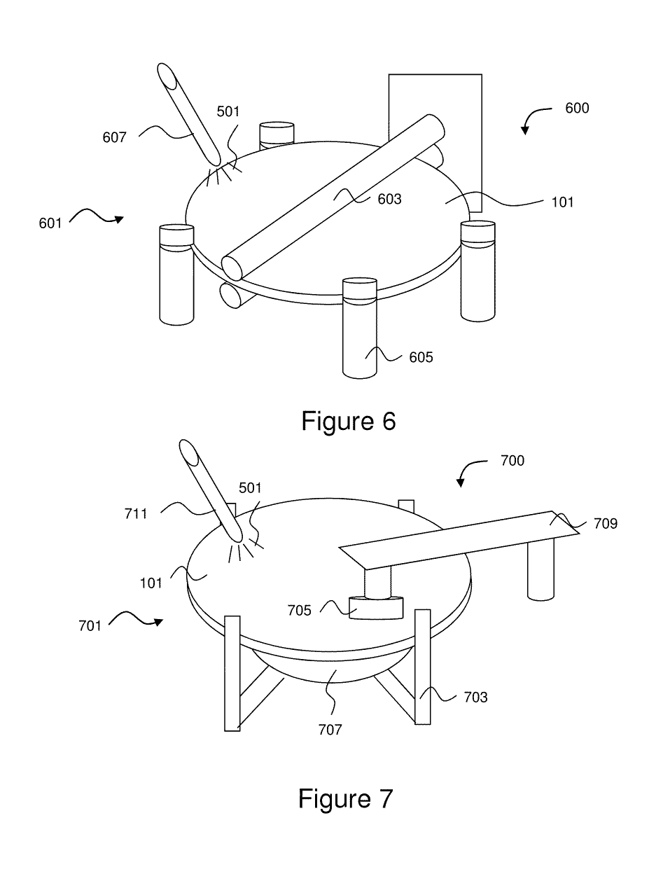

After the cleaning buffing CMP process 500, the substrate 101 may be moved to the cleaning station 205 (see FIG. 2), where an additional brush cleaning process 600 may be performed in order to further clean the first polishing stop layer 111. FIG. 6 illustrates a brush cleaning system 601 that may be utilized in the cleaning station 205, and in an embodiment the substrate 101 and the first polishing stop layer 111 may be placed into a brush cleaning system 601 which may comprise cleaning members 603 and spindles 605. The cleaning members 603 may be roll type sponge cleaning members and may be formed from, e.g., a porous poly vinyl alcohol (PVA) sponge, although any suitable cleaning members 603 may alternatively be utilized. The spindles 605 may be utilized to hold the substrate 101 in position for the brush cleaning process 600.

During the brush cleaning process 600 the spindles 605 may hold the substrate 101 and also rotate the substrate 101 while the cleaning members 603 are contacted to the top and bottom surfaces of the substrate 101 (including the first polishing stop layer 111). Additionally, the cleaning solution 503 (described above with respect to FIG. 5A) may be applied to the first polishing stop layer 111 through a cleaning solution dispenser 607 in order to assist in the further removal of the particles 401 and organic material 403.

In an embodiment of the brush cleaning process 600, the cleaning members 603 may be rotated at about a speed of between about 70 rpm and about 200 rpm, such as about 90 rpm, while the substrate 101 may be rotated at a speed of between about 50 rpm and about 400 rpm, such as about 120 rpm. Additionally, the cleaning solution 501 may be mixed with additional solvent (e.g., deionized water), and collectively dispensed at a flow rate of about 1 liter per minute, with the cleaning solution 501 being dispensed at about 300 sccm and the additional solvent being dispensed at about 700 sccm of additional solvent.

FIG. 7 illustrates an additional pencil brush cleaning process 700 that may be utilized to further clean the first polishing stop layer 111. In an embodiment the substrate 101 may be placed into a pencil brush cleaning system 701 that comprises chucks 703 attached to a rotatable body 707 which may be used to rotate the substrate 101. The pencil brush cleaning system 701 may also comprise a pencil brush 705, with cleaning bristles attached to it, attached to a pivot arm 709 that can control the placement and pressure of the pencil brush 705 in relation to the substrate 101.

During the pencil brush cleaning process 700, the rotatable body 707 may rotate the substrate 101 at a speed of between about 500 rpm and about 2000 rpm, such as about 1500 rpm, while the pencil brush 705 may be rotated at a speed of between about 50 rpm and about 200 rpm, such as about 100 rpm, while the pivot arm 709 moves the pencil brush 705 across the first polishing stop layer 111. In an embodiment the substrate 101 may be rotated in a same direction as the pencil brush 705, although the substrate 101 and the pencil brush 705 may alternatively be rotated counter to each other. Additionally, the pivot arm 709 may be used to apply a force of between about 0.5 N and about 10 N, such as about 2 N, to the pencil brush 705 for between about 5 seconds and about 40 seconds, such as about 15 seconds.

Additionally, the cleaning solution 501 (described above with respect to FIG. 5) may also be supplied to the first polishing stop layer 111 through a cleaning solution dispenser 711. The inclusion of the cleaning solution 501 helps to further clean the first polishing stop layer 111, removing the particles 401 and organic material 403. The cleaning solution 501 also helps to change the first polishing stop layer 111 from hydrophobic to hydrophilic, helping to reduce the number of particles 401 and organic material 403 that may be located on the first polishing stop layer 111.

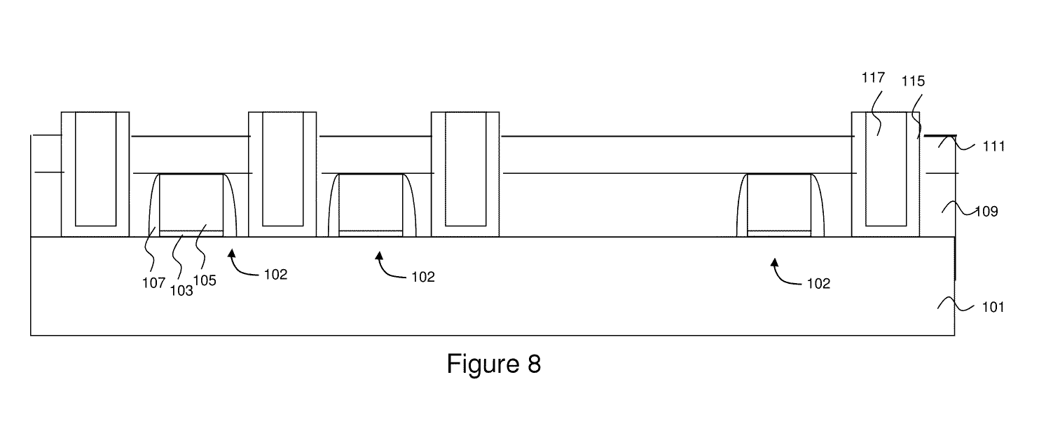

FIG. 8 illustrates the result of an embodiment which utilizes the cleaning buffing CMP process 500 (described above with respect to FIG. 5A), the brush cleaning process 600 (described above with respect to FIG. 6), and the pencil brush cleaning process 700 (described above with respect to FIG. 7. As illustrated, the particles 401 and organic materials 403 have been removed from the surface of the first polishing stop layer 111. Without the particles 401 and organic materials 403 present during later manufacturing steps, fewer defects may occur, thereby leading to an overall improvement in quality and yield for the manufacturing process.

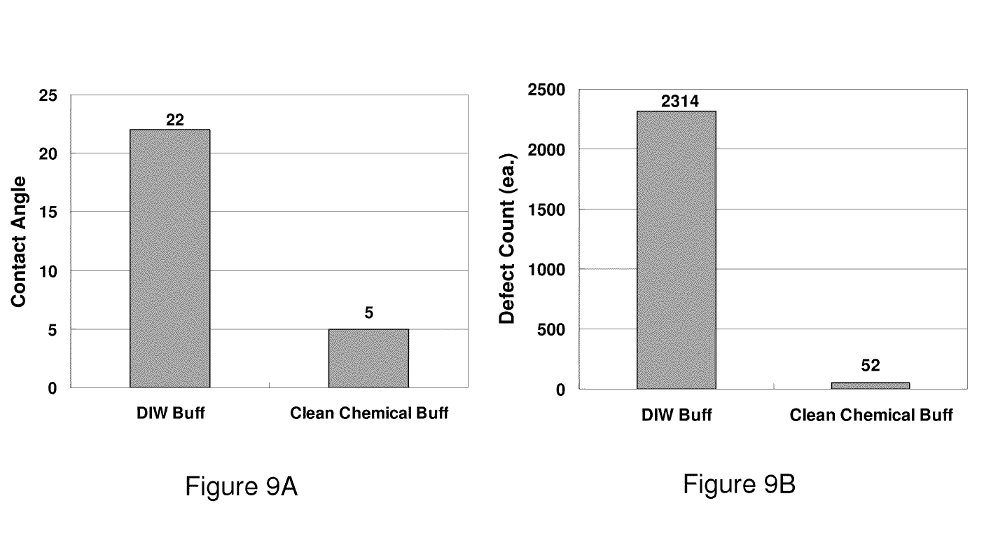

FIGS. 9A and 9B illustrate test results that show this improvement that may be obtained from the embodiments. FIG. 9A illustrates the contact angle (which may be used as a measure of the hydrophilic nature of the first polishing stop layer 111) after using a simple deionized water buff and a contact angle after performing a buff with the cleaning solution 501 as described above. As illustrated, the use of the cleaning solution 501 can lower the contact angle from 22 to 5, illustrating the change from hydrophobic to hydrophilic.

FIG. 9B illustrates a defect count after using a simple deionized water buff and also for a buff utilizing the cleaning solution 501. As illustrated, the deionized water buff has a defect count of 2314 e.a., while the buff with the cleaning solution 501 has a defect count of 52 e.a, a 97.7% reduction in the defect count. As such, from both of these charts, utilizing the cleaning solution 501 greatly lowers the number of defects and improves the overall process.

In accordance with an embodiment, a method for cleaning a semiconductor device comprising polishing a material away from a first surface of a dielectric layer is provided. The first surface of the dielectric layer is buff polished with a reactant, wherein the buff polishing changes at least a portion of the first surface from hydrophobic to hydrophilic.

In accordance with another embodiment, a method of cleaning a surface of a semiconductor device comprising polishing a first material away from a first surface and buffing the first surface with a first cleaning solution, the first cleaning solution comprising a first reactant to remove a portion of the first surface and make the first surface more hydrophilic is provided. The first surface is cleaned with a second cleaning solution, the second cleaning solution comprising a second reactant that will make the first surface more hydrophilic.

In accordance with yet another embodiment, a method of cleaning a first surface of a semiconductor device comprising polishing a sacrificial layer from the first surface, wherein the first surface is silicon nitride, is provided. The first surface is buffed using a first cleaning solution, the first cleaning solution comprising phosphoric acid, and the first surface is contacted with a brush roller and a second cleaning solution comprising phosphoric acid. The first surface is contacted with a pencil brush and the second cleaning solution.

Although the embodiments and their advantages have been described in detail, it should be understood that various changes, substitutions and alterations can be made herein without departing from the spirit and scope of the embodiments as defined by the appended claims. For example, the precise compositions of the cleaning solution may be adjusted while remaining within the scope of the embodiments. Further, different combinations of the cleaning processes described above may alternatively be utilized.

Moreover, the scope of the present application is not intended to be limited to the particular embodiments of the process, machine, manufacture, composition of matter, means, methods and steps described in the specification. As one of ordinary skill in the art will readily appreciate from the disclosure of the embodiments, processes, machines, manufacture, compositions of matter, means, methods, or steps, presently existing or later to be developed, that perform substantially the same function or achieve substantially the same result as the corresponding embodiments described herein may be utilized according to the embodiments. Accordingly, the appended claims are intended to include within their scope such processes, machines, manufacture, compositions of matter, means, methods, or steps.

What is claimed is:

1. A method for cleaning a semiconductor device, the method comprising:
polishing a material away from a first surface of a dielectric layer; and
buff polishing the first surface of the dielectric layer with a reactant, wherein the buff polishing changes at least a portion of the first surface from hydrophobic to hydrophilic.

2. The method of claim 1, wherein the reactant is phosphoric acid.

3. The method of claim 1, wherein the reactant is oxalic acid.

4. The method of claim 1, wherein the reactant is citric acid.

5. The method of claim 1, further comprising brushing the first surface of the dielectric layer with the reactant after the buff polishing the first surface of the dielectric layer.

6. The method of claim 5, further comprising pencil scrubbing the first surface of the dielectric layer with the reactant after the brushing the first surface of the dielectric layer.

7. The method of claim 1, wherein the buff polishing the first surface of the dielectric layer further comprises contacting the first surface with a surfactant that will assist the reactant to change the first surface from hydrophobic to hydrophilic.

8. The method of claim 7, wherein the surfactant is perfluorooctanoic acid.

9. A method of cleaning a surface of a semiconductor device, the method comprising:
polishing a first material away from a first surface;
buffing the first surface with a first cleaning solution, the first cleaning solution comprising a first reactant to remove a portion of the first surface and make the first surface more hydrophilic; and
cleaning the first surface with a second cleaning solution, the second cleaning solution comprising a second reactant that will make the first surface more hydrophilic.

10. The method of claim 9, wherein the polishing the first material further comprises:
polishing a conductive material away from a sacrificial layer; and
polishing the sacrificial layer away from the first surface.

11. The method of claim 10, wherein the conductive material is tungsten.

12. The method of claim 9, wherein the first reactant is phosphoric acid.

13. The method of claim 9, wherein the first cleaning solution further comprises a surfactant that will make the first surface more hydrophilic.

14. The method of claim 9, wherein the cleaning the first surface further comprises:
contacting a polyvinyl alcohol roller to the first surface; and
contacting a pencil brush to the first surface after the contacting the polyvinyl alcohol roller.

15. A method of cleaning a first surface of a semiconductor device, the method comprising:
polishing a sacrificial layer from the first surface, wherein the first surface is silicon nitride;
buffing the first surface using a first cleaning solution, the first cleaning solution comprising phosphoric acid;
contacting the first surface with a brush roller and a second cleaning solution comprising phosphoric acid; and
contacting the first surface with a pencil brush and the second cleaning solution.

16. The method of claim 15, wherein the first cleaning solution further comprises a surfactant.

17. The method of claim 16, wherein the surfactant is perfluorooctanoic acid.

18. The method of claim 15, wherein the second cleaning solution is the same as the first cleaning solution.

19. The method of claim 15, wherein the polishing the sacrificial layer is performed using a first polishing pad and the buffing the first surface is performed using the first polishing pad.

20. The method of claim 15, wherein the brush roller is a PVA brush.
